(19) United States
(12) Patent Application Publication
(10) Pub. No.: US 2025/0264684 A1
(43) Pub. Date: Aug. 21, 2025

(54) ROUTING FIBER OPTIC DISTRIBUTION CABLES WITH SERVICE DROP LINES ON THE FAÇADE OF A MULTIDWELLING UNIT (MDU) BUILDING

(71) Applicant: OFS Fitel, LLC, Norcross, GA (US)

(72) Inventors: Mark A Boxer, Pinetown, NC (US); John E George, Cumming, GA (US); Henson P Toland, Atlanta, GA (US); Howard M Kemp, Brandon, FL (US)

(73) Assignee: OFS Fitel, LLC, Norcross, GA (US)

(21) Appl. No.: 19/201,651

(22) Filed: May 7, 2025

Related U.S. Application Data
(63) Continuation-in-part of application No. 18/023,841, filed on Feb. 28, 2023.
(60) Provisional application No. 63/073,201, filed on Sep. 1, 2020.

(51) Int. Cl. G02B 6/46; G02B 6/44

(52) U.S. Cl. CPC G02B 6/47; G02B 6/4434; G02B 6/4446; G02B 6/44515

(57) ABSTRACT

A procedure for providing fiber optic service to users in living units inside a multidwelling unit (MDU) building having an outside wall or façade. A number of connection enclosures are fixed on the façade along a path extending in the region of a set of living units to be serviced via associated drop lines. A feeder cable containing fibers assigned to service the living units is routed through the enclosures. Inside a given enclosure, fibers of a given drop line are connected to a set of fibers in the feeder cable that are assigned to service a living unit with which the line is associated. Before the drop lines pass through the façade to enter the living units, the lines are managed over the façade by inserting them into one or more cable support members that are fastened to the façade and in which the feeder cable is also inserted for support.

### CROSS REFERENCE TO RELATED APPLICATIONS

This application is a continuation-in-part (CIP) of our co-pending U.S. patent application Ser. No. 18/023,841 filed Feb. 28, 2023, and titled Supporting and Routing Drop Lines From an All-Dielectric Self Supporting (ADSS) Fiber Optic Trunk Cable. The '841 application is a national stage application under 35 U.S.C. § 371 of PCT/US21/48432 filed Aug. 31, 2021, which claims the benefit of U.S. Provisional Patent Application No. 63/073,201 filed Sep. 1, 2020.

### BACKGROUND OF THE INVENTION

### Field of the Invention

The present invention relates to managing fiber optic distribution cables and associated service drop lines on the façade of a multidwelling unit (MDU) building, for servicing users in the building.

### Discussion of the Known Art

To provide communications or network services, for example; Internet, television, telephony, various data streams, and the like to users in a MDU building, providers must route a number of service drop lines that originate from a main trunk or distribution cable, to a number of living units inside the building where users of the services reside.

Modern distribution cables are typically fiber optic cables, some of which may have an all-dielectric, self-supporting (ADSS) construction. Optical fibers contained in the cables can supply so-called Fiber-to-the-Home (FTTH) services including the network services noted above. In particular, ADSS cables are self-supporting over specified distances when anchored or attached at opposite ends to poles, towers, or other fixed structures. And because they have no metallic components, they present no safety hazard when deployed near high voltage power lines which produce strong electric fields. The fibers in ADSS cables may be routed loosely inside flexible, gel-filled or gel-free buffer tubes (so called “loose tube” cables), or arranged in ribbon configurations. See, e.g., U.S. Pat. No. 9,323,019 (Apr. 26, 2016) and U.S. Pat. No. 10,591,691 (Mar. 17, 2020), all relevant portions of which are incorporated by reference.

FIG. 1 is a cross-sectional profile of a typical loose tube ADSS fiber optic cable 10 sold by OFS Fitel, LLC under the registered trademark PowerGuide Short Span DT. The cable is intended for light duty, short span, non-custom applications. As seen in the drawing, the cable 10 includes:
A central dielectric strength or tension rod member 12 made of epoxy-fiberglass;
Gel-free buffer tubes 14 stranded about the central rod member 12 with a reverse oscillating lay (ROL) twist;
Optical fibers 16 routed inside the buffer tubes 14;
A water swellable yarn 18 or other water blocking material routed with the fibers inside each tube 14;
Dry water blocking materials 20 applied over the tubes 14;
Dielectric strength members 22; and
A medium-density polyethylene (MDPE) outer jacket 24.

For many years, telephone and cable television service providers have lashed both the trunk and the service drop cables to a separate metallic messenger wire or cable for support. While a given span of a fiber optic trunk cable may not have enough tensile strength to bear the increased load of one or more traditional copper wire cables when lashed to the trunk cable, today's all fiber networks may reduce or eliminate the need for separate support wires or cables. In fact, fiber optic cables are now preferred for use in new installations as they require less installation time and preparation, little or no regular maintenance, and minimal cable anchoring requirements, thereby yielding a greater return on investment.

Notwithstanding, because of issues concerning the management of service drop lines for individual users from a fiber optic trunk cable, some industry consultants still recommend that standard loose tube fiber cables be lashed onto existing copper trunk cables when the loose tube cables are used as drop lines. Such recommendations may be based on common practices in the telephone and cable TV industries that call for lashing telephone and coaxial TV cables onto steel messenger wires whose ends are anchored to poles or other fixed structures. The steel messenger wires are by definition conductive, and thus require additional clearances from other metallic cables in comparison with ADSS fiber optic cables. Such lashing can result in significant costs by requiring extensive work to make existing poles ready for the additional lashed cables.

The above “make ready” process involves moving cables up and down on a given pole to comply with cable-to-cable and cable-to-ground clearance requirements specified by the National Electric Safety Code (NESC). In some cases, poles may need to be replaced to enable compliance. In one known situation, the cost of such change-outs was $1.25/foot or $6,600/mile, which is much higher than the cost of deploying an exclusively fiber network.

Moreover, until the present invention, there was no known reliable and aesthetically viable system for managing and supporting service drop lines from a fiber optic trunk cable. Industry requirements limit the strain on fibers contained in fiber optic cables to less than 0.2% over the lifetime of the fibers. Lashing drop lines to a trunk cable will increase the overall weight of the attached lines and cable, and their effective diameter with respect to wind or icing. Nevertheless, drop lines ordinarily do contain strength members to control strain. There are two ways to model how the addition of drop lines to a fiber optic trunk cable affect strain:
(1) The trunk cable absorbs all of the load from all cables.
(2) The trunk cable the and the drop lines behave as a coupled system, so the additional amount of strain added to the trunk cable by the drop lines is reduced since the drop lines will also absorb load.

Testing to determine which model governs when drop lines are coupled to a trunk cable is also contemplated by the present invention.

Known devices for supporting two or more lines or cables along a given span include (i) Preformed Line Product (PLP) bushings that may hold multiple drop lines inside of a tangent clamp, (ii) rubber bands, (iii) electrical conductor spacing devices, and (iv) AFL Telecommunications tangent clamps combined for two lines.

An outdoor enclosure for protecting splices or connections of fibers in a service drop line, with fibers in a feeder or distribution cable which have been assigned to connect with the fibers in the drop line, is available from OFS Fitel, LLC under the registered mark SlimBox®. The enclosure is constructed for mounting on the façade of a MDU building, and is designed for inline applications wherein the feeder cable is routed on the façade to enter either the left or the right side of the enclosure, and fibers of one or more drop lines are spliced or connected to assigned fibers in the feeder cable. The feeder cable can then exit the opposite side of the enclosure, and be routed to other enclosures on the façade in order to connect with the fibers in any additional drop lines.

Notwithstanding, there is a need for a system or procedure that allows multiple service drop lines to be routed on the façade of a MDU building in a way that does not create an aesthetically unpleasant appearance or footprint in which the drop lines may hang loosely or extend long distances on the façade without adequate support, before the lines pass through the façade and are routed to living units inside the building.

### SUMMARY OF THE INVENTION

According to the invention, a procedure for providing fiber optic communication services to users residing in living units inside a multidwelling unit (MDU) building having an outside wall or façade, includes fixing a number of connection enclosures on the façade at determined locations along a given path on the façade, wherein the path extends in the region of a set of living units to be serviced via associated service drop lines. A fiber optic distribution or feeder cable is routed through the enclosures fixed on the façade and the cable contains fibers assigned to service the set of living units. Inside a given enclosure, fibers of a given drop line are spliced or connected to a set of fibers in the distribution cable that have been assigned to service a living unit with which the drop line is associated.

The drop lines from the connection enclosures fixed on the building façade are routed to their associated living units, by clamping the drop lines to the distribution cable at determined locations between successive ones of the connection enclosures on the façade before passing the lines through the façade for routing to the living units. The drop lines are thus managed and adequately supported over the façade, and an aesthetically unpleasant appearance or footprint on the façade is avoided.

For a better understanding of the invention, reference is made to the following description taken in conjunction with the accompanying drawing and the appended claims.

### BRIEF DESCRIPTION OF THE DRAWING FIGURES

In the drawing:

FIG. 1 is a cross-sectional view of a known ADSS fiber optic cable;

FIG. 2 is a perspective view of a first embodiment of a cable support member;

FIG. 3 is a cross-sectional view of a second embodiment of a cable support member;

FIG. 4 shows a span of an ADSS cable with the inventive cable support members placed at intervals along the span, and drop lines supported by the members for routing to designated users;

FIG. 5 is a cross-sectional view of a third embodiment of a cable support member;

FIG. 6 is a cross-sectional view of a fourth embodiment of a cable support member suitable for use on the façade of a multiple dwelling unit (MDU) building, according to the invention;

FIG. 7 is a bottom view of the cable support member in FIG. 6;

FIG. 8 shows a MDU building façade over which a fiber optic feeder cable and associated service drop lines are routed, according to the invention; and

FIGS. 9(a) to 9(c) are cross-sectional views of additional embodiments of cable support members, according to the invention.

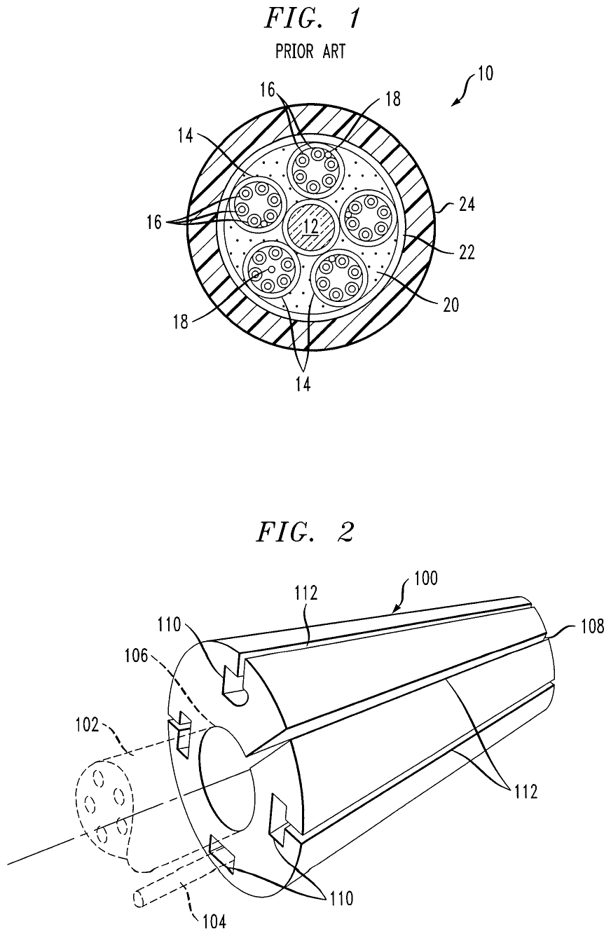

### DETAILED DESCRIPTION OF THE INVENTION

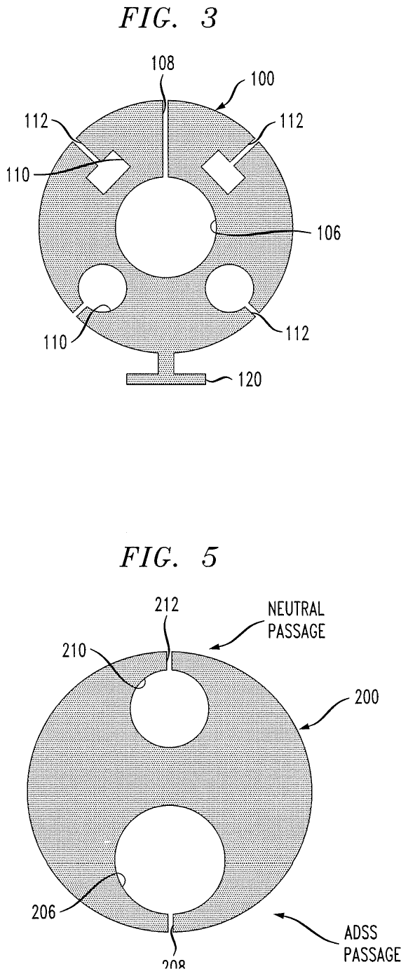

FIGS. 2 and 3 show two embodiments of a cable support member 100 according to one aspect of the invention. When placed at determined intervals along a span of a trunk or distribution cable 102 (see FIG. 4), the members 100 enable a number of service drop lines 104 together with other cables or dielectric strands, to be supported by the cable 102 along the length of the span. The distribution cable 102 may be, for example, an ADSS cable available from OFS Fitel, LLC under the registered marks “PowerGuide” and “AccuTube.” The service drop lines 104 may be, e.g., flat, round loose tube or tight buffered cables available from OFS under the mark “mini LT”.

In the illustrated embodiments, the support member 100 is in the form of an elongated, non-metallic or dielectric circular cylinder. It will be understood, however, that the overall shape of the support member 100 may be other than circular cylindrical depending on a given application. The material forming the support member 100 may be ethylene propylene died monomer (EPDM) rubber, or an equivalent resilient, weather resistant material.

The member 100 has a central passage or opening 106 formed axially over the length of the member, and the passage 106 is sized to receive and contain a corresponding length of the trunk cable 102. The passage 106 has an associated first slit or slot 108 formed to open between the circumference of the support member 100 and the central passage 106 over the length of the member when the cable 102 is urged sideways through the slit 108 from outside the member and received in the central passage 106. The slit 108 need not have a straight line profile as shown, but may have a wavy or curvilinear profile so as to decrease the likelihood that after the cable 104 is received in the passage 106, the cable will not fall out of the support member 100 through the slit 108.

In addition, the support member 100 has a number of outer passages 110 formed axially in the member 100 over the length of the member. Each outer passage 110 is sized to receive and contain one or more drop lines 104, and has an associated second slit or slot 112 over the length of the support member 100 which opens between the circumference of the member and the outer passage 110 when a given drop line 104 is urged sideways through the second slit 112 from outside the member and received in the outer passage 110. The passages 106, 110, and the slits 108, 112, can be formed while the support member 100 is molded or extruded.

As shown in FIG. 2, all of the outer passages 110 in the support member 100 may be sized to accommodate flat drop lines 104, or, as shown in FIGS. 3 and 4, at least some of the outer passages 110 may be sized to contain round drop lines, dielectric strands, or metallic support wires, as needed. Typical dimensions (in mm) for the support member 100 are:
Length of support member 100: Approximately 150 mm
Outside Diameter of support member 100: Approximately 45 mm
Diameter of central passage 106: Sized to diameters of cables
Dimensions of flat outer passages 110: Sized to diameters of cables
Diameters of round outer passages 110: Sized to diameter of cables
Rubber durometer: 70, although other formulations may be used

The support member 100 may also have a generally T-shaped, thick rubber nub 120 that can be molded integrally with the member to project from the bottom of the member as viewed in FIG. 3. The nub 120 is dimensioned and formed to anchor, e.g., a UV protected EPDM rubber band after the band is firmly wound about the member 100 with the trunk cable 102 and the drop lines 104 contained in the member passages, thus preventing the cable and the lines from leaving the passages through their associated slits 108, 112.

As shown in FIG. 4, the support members 100 may be placed at determined intervals of, e.g., 50 to 100 feet along a first span of the trunk cable 102. The drop lines 104 originate from a splice closure 130 that can be mounted on a pole 132 or other fixed structure at one end of the span. At the splice closure 130, a first set of fibers in the cable 102 are spliced or connected to corresponding fibers of the drop lines 104. The drop lines 104 may be wound about the trunk cable 102 or otherwise bound to the cable for support.

At a first location A along the first span, the trunk cable 102 is urged trough the first slit 108 in the support member 100 and received in the central passage 106 in the member. Drop lines 104 that have been wound about the cable 102 and destined to users at or beyond the first location A, are urged through the second slits 112 and received in the outer passages 110 in the first support member 100. One or more of the drop lines 104 exiting the outer passages 110 in the first support member 100 and destined to designated users at the first location A, are then routed away from the cable 102 to the users.

Remaining drop lines 104 continue to be wound along the first span of the trunk cable 102 to a second location where one or more of the drop lines 104 are destined to users at the second location or beyond. The cable 102 is received in the central passage 106 of a second support member 100 at the second location B, and the drop lines 104 are received in corresponding outer passages 110 in the second support member. Those drop lines 104 exiting the outer passages 110 in the second support member 100 and destined to designated users at the second location B, are then routed away from the cable 102 to service the users. The remaining drop lines 104 continue to be wound along the span of the trunk cable 102 to a third location where one or more of the drop lines 104 are destined to users at the third location. The cable 102 is received in a third support member 100 at the third location, and the remaining drop lines 104 are received in corresponding outer passages 110 in the third support member. The drop lines 104 exiting the outer passages 110 in the third support member 100 and destined to users at the third location, are then routed away from the cable 102 to service the users.

Once all the drop lines 104 wound about the first span of the trunk cable 102 are routed to designated users located along the first span, a second set of fibers in the cable are spliced or connected to corresponding fibers in a second set of drop lines 104 in a second splice closure 130 associated with a second span (not shown in FIG. 4) of the cable 102. As before, the second set of drop lines 104 are wound about or otherwise bound to the second cable span for support. The cable 102 and the drop lines 104 are received in the corresponding passages in one or more successive support members 100 at locations along the second span of the cable where the drop lines are destined to users located along the second span. At each location, one or more of the drop lines 104 exiting a support member 100 at the location and destined to users at the location, are routed away from the cable 102 to the users.

As disclosed herein, the inventive system including the support members 100 allow user drop lines to be supported by a span of a given trunk cable, and can also allow one or more additional cables to be supported along the given cable. Other advantages include:
1. The support members 100 allow the drop lines 104 to be deployed on an “as needed” basis.
2. The slit 112 in the support members 100 can be opened and closed repeatedly to allow additional drop lines 104 to be received in the outer passages 110 in the members and routed to new users, without interrupting service to existing users via the trunk cable 102.
3. Each support member 100 can be used with different numbers, sizes, and shapes of drop lines 104.
4. One of the outer passages 110 in the members 100 can be formed to receive and contain a separate dielectric strand to counter additional load tensions produced by the drop lines 104.
5. The support members 100 can be formed with passages to accommodate different numbers and shapes of drop lines or dielectric strands. Additional central passages may also be formed to accommodate trunk cables having different outside diameters.
6. The support members 100 can be used with a dielectric strength member and a mid-span drop dead end, to enable deployment of mid-span drops without an additional lashing wire.

It will be understood that any published maximum rated cable load (MRCL) for a given ADSS trunk cable may need to be modified in view of added loading by the drop lines 104 through the support members 100, with the drops occurring either mid-span or at poles. Any such increased loading may be kept at a minimum by attaching drop lines only when a corresponding number of customers sign up, and only when additional drop lines are otherwise needed.

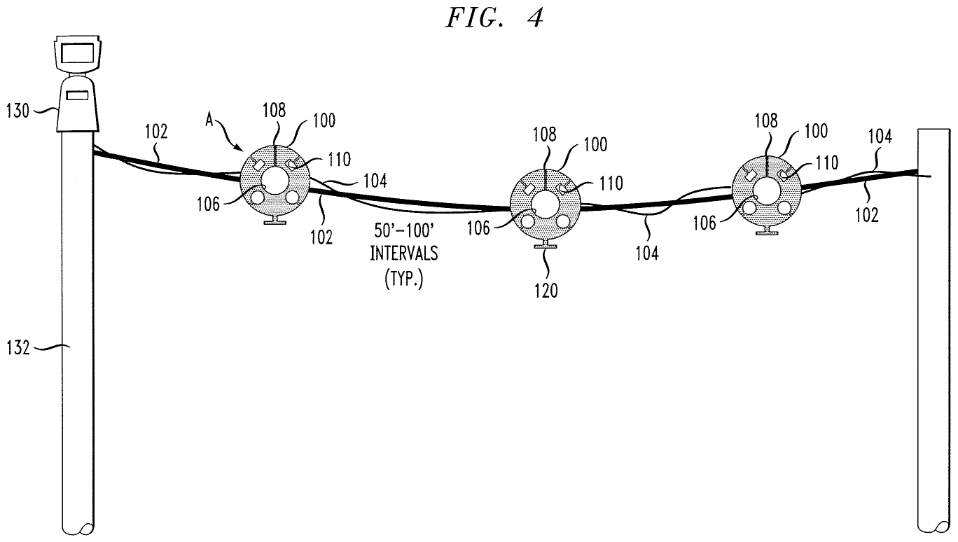

FIG. 5 is a cross-sectional profile of a third embodiment of a cable support member 200 according to the invention. The member 200 has a first or main passage 206 formed axially over the length of the member, and the passage 206 is sized to receive and contain a length of a trunk cable. The passage 206 has an associated first slit or slot 208 formed through the wall of the member 200 so that when the cable is urged sideways through the slit 208 from outside the member, the cable can be received and contained in the main passage 206.

In addition, the support member 200 has a second passage 210 formed axially over the length of the member. The second passage 210 is sized to receive and contain a non-metallic or metallic support cable such as an electrical neutral, and has an associated second slit or slot 212 formed through the wall of the member 200 so that when a support cable is urged sideways through the slit 212 from outside the member 200, the support cable can be received and contained in the second passage 210. The passages 206, 210, and the slits 208, 212, may be formed, for example, while the support member 200 is being molded or extruded.

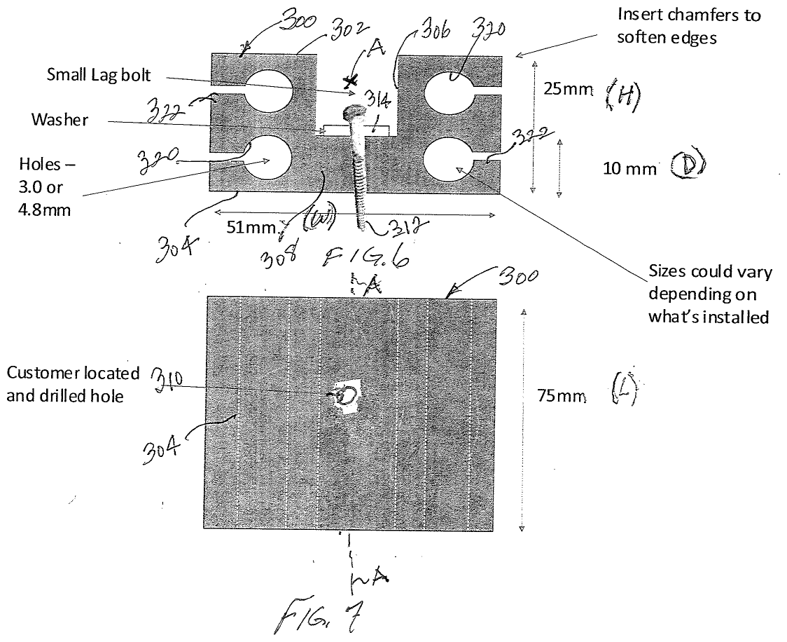

FIG. 6 is a cross sectional view of a fourth embodiment of a cable support member 300 according to the invention. The support member 300 can be used to secure one or more service drop lines to a fiber optic distribution or feeder cable, when the feeder cable is routed over the façade of a multiple dwelling unit (MDU) building. FIG. 7 is a bottom view of the support member 300 in FIG. 6.

In the embodiment of FIG. 6, the support member 300 is in the shape of an elongated rectangular block having a long axis A, a top surface 302, and a bottom surface 304 shown in FIG. 7. The member 300 can measure, for example, approximately 51 mm wide (W), 25 mm high (H), and 75 mm long (L). The member may be extruded or formed of, e.g., EPDM or equivalent resilient dielectric material that is durable enough for outdoor use and which can be painted, if desired.

The top surface 302 of the support member 300 has an axially directed central passage or channel 306 the bottom of which is spaced a determined distance, e.g., 10 mm (D) from the clamp bottom surface 304 to define a base 308 of the member. The channel 306 is dimensioned and formed to receive a feeder cable when urged into the top of the channel 306, and to retain the cable in the channel, e.g., by friction or by a cap inserted in top of the channel 306.

A central guide hole 310 is drilled or otherwise formed through the base 308 for passage of a bolt 312 or other fastener to mount the member 300 at one or more selected locations on a building façade. Before the member 300 is mounted, a hole for receiving the fastener 312 may be drilled into the surface of a brick or concrete façade at each location. A washer 314 is preferably disposed beneath the head of the fastener 312 before the base 308 of the member 300 is tightened against the façade by the fastener 312. Alternatively, in applications where a feeder cable and associated service drop lines are to be routed vertically, flexible tie wraps may be used to mount the base 308 of the clamp 300 onto, for example, a vertical down spout of a building gutter system.

As seen in FIG. 6, the cable support member 300 has a number of axial passages 320 each of which is dimensioned and formed to receive and retain a service drop line associated with a feeder cable in the channel 306. The passages 320 may have diameters ranging between, for example, approximately 3.0 and 4.8 mm, depending on the diameters of the service drop lines to be retained in the passages. Each passage 320 has an associated slit opening 322 formed between the passage and the outside surface of the support member 300, so that a given drop line can be urged sideways through the slit opening 322 and received in a corresponding passage 320. The number and shape of the passages 320 in the support member 300, as well as the overall shape of the support member, may vary depending on the number and shape (e.g., round or flat) of the service drop lines expected to be accommodated by the member 300,

As mentioned, the material from which the support member 300 is made should be resilient or deformable enough to allow a drop line to be urged through each slit 322 to enter the associated passage 320, and for the material to regain its initial shape sufficiently to restrain the drop line from axial movement relative to the member 300.

FIG. 8 shows a MDU building façade 340 over which a fiber optic distribution or feeder cable 342 and a number of associated service drop lines 344 are routed, according to the invention. As used herein, the term “façade” refers broadly to any outside or exterior wall of a MDU building, the surface of which is accessible to installers and is capable of supporting as many cables as may be needed to provide communication or network services to persons residing in the building.

A number of connection enclosures 346, each of which may be the earlier mentioned “SlimBox” inline façade enclosure or equivalent; are fixed at determined locations on the façade 340 along a path that extends near (e.g., above and/or below) a set of living units 348 to be serviced via the drop lines 344. Inside a given enclosure 346, the fibers of a given drop line 344 are spliced or connected to a set of fibers in the distribution cable 342 assigned to service a living unit 348 with which the given drop line 344 is associated.

The drop lines 344 from the connection enclosures 346 are routed over the façade 340 to points outside the living units 348 associated with the lines. For each drop line 344, a hole or passage is made through the façade, and the line 344 is passed through the hole and routed to the associated living unit inside the building. At the living unit, the drop line 344 may be connected to an optical network terminal (ONT) or other user device in the unit. Typically, one feeder cable 342 containing multiple optical fibers can service as many as 16 living units with corresponding drop lines 344.

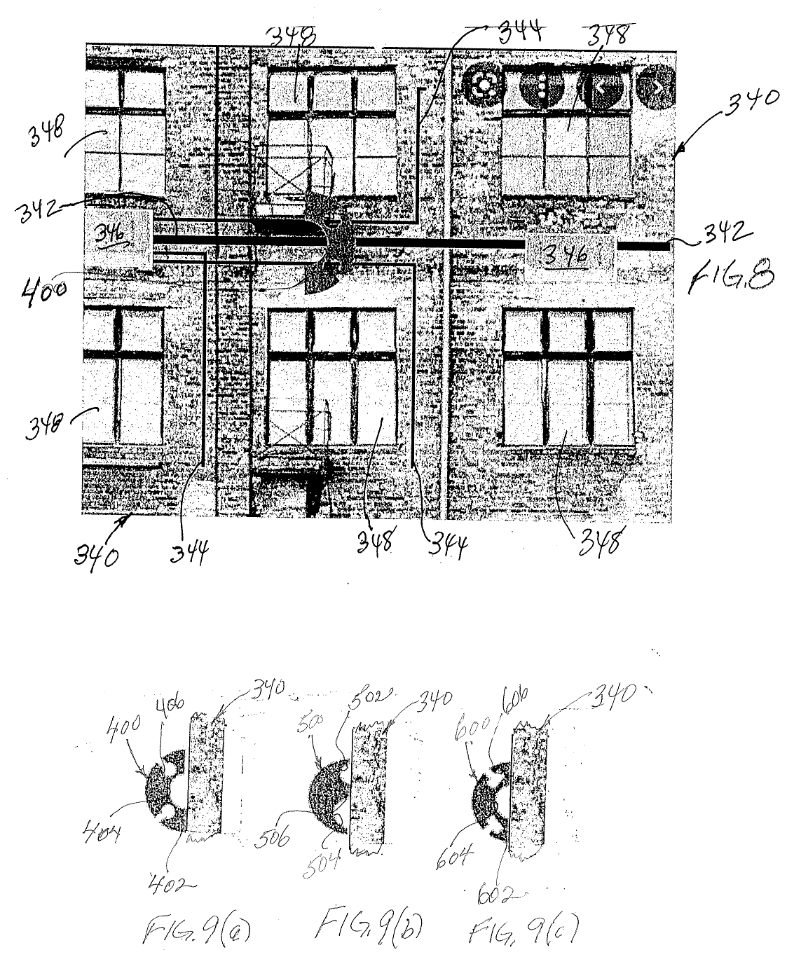

The drop lines 344 are mounted and supported over the façade 340 by using one or more of the cable support members 300 to clamp each of the lines 344 to the feeder cable 342 at determined locations between successive ones of the connection enclosures 346 fixed on the façade 340, before each line 344 is passed through the façade for routing to an associated living unit. Alternatively, one or more of the cable support members 400, 500, or 600 shown in FIGS. 9(a) to 9(c) may be deployed instead, for example, the support member 400 depicted in FIG. 8. As a result, the drop lines 344 are securely supported and restrained from hanging loose over the façade. An aesthetically unpleasant footprint or appearance on the façade is thus avoided.

Moreover, it will be appreciated that the support member 300 allows service drop lines to be deployed on an “as needed” basis from a given feeder cable, and the member can be repeatedly opened and closed to accommodate additional drop lines after initial installation, and without interruption of service. The passages 306, 320 in each support member 300 may also be dimensioned and formed to accommodate different shapes, sizes, and numbers of cables, and the member 300 may be painted or otherwise modified to improve the installation footprint aesthetically.

FIGS. 9(a) to 9(c) are cross-sectional views of additional embodiments of cable support members 400, 500, and 600, according the invention. Support members 400 and 600 have generally semicircular cross-sections, and are fastened to the façade 340 at first ends 402, 602 of the members. Each of the support members 400, 600 has a semicircular passage 404, 604 for receiving and restraining a feeder cable when the support member is fastened to the façade 340. The members 400, 600 also have axial passageways 406, 606 in which service drop lines can be received through corresponding slits or openings 408, 608 in the member.

Cable support member 500 also has a generally circular cross-section, and two semicircular axial passages 502, 504. Each passage is dimensioned for receiving and restraining a feeder cable or a service drop line, when the member 500 is fastened at or near its axis 506 to the façade 340. Like the support member 300, the members 400, 500, and 600 may be formed of EPDM or equivalent material durable enough for outdoor use and paintable if desired.

While the foregoing represents preferred embodiments of the present invention, it will be understood by persons skilled in the art that various changes, modifications, and additions can be made without departing from the spirit and scope of the invention, and that the invention includes all such changes, modifications, and additions that are within the scope of the following claims.

We claim:

1. A procedure for providing fiber optic service to users residing in living units inside a multidwelling unit (MDU) building having an outside wall or façade, comprising:
fixing a number of connection enclosures on the building façade at determined locations along a given path on the façade, wherein the path extends in the region of a set of living units to be serviced via associated service drop lines;
routing a fiber optic distribution or feeder cable through the enclosures fixed on the façade along the given path, wherein the cable contains fibers assigned to service the set of living units;
inside a given connection enclosure, splicing or connecting fibers of a given drop line to a set of fibers in the feeder cable that have been assigned to service a living unit with which the drop line is associated;
fastening a cable support member at determined locations between successive ones of the connection enclosures fixed on the façade, and inserting the feeder cable in each cable support member;
routing the service drop lines from the connection enclosures fixed on the building façade to the living units with which the drop lines are associated, including supporting the drop lines by inserting the lines in the cable support members in which the feeder cable is inserted; and
passing the service drop lines through the façade for routing to the living units.

2. The procedure of claim 1, including performing the drop line supporting step by forming a first axial passage in each support member for receiving and retaining the feeder cable, and one or more second axial passages for receiving and retaining corresponding ones of the service drop lines, and forming each support member with a mounting portion for enabling the support member to be fastened to the façade.

3. The procedure of claim 2, including forming gap or slit openings between the outside surface of each support member and the first and the second axial passages in the member, and urging the feeder cable and the drop lines through the openings from the outside surface into the corresponding passages.

4. The procedure of claim 2, including forming the second axial passages in each cable support member to accommodate a desired number, shape, and/or size of the service drop lines.

5. The procedure of claim 2, including forming the cable support member in the shape of a generally rectangular block.

6. The procedure of claim 2, including forming the cable support member to have a generally semicircular cross section.

7. The procedure of claim 2, wherein the second axial passages are formed to receive and retain service drop lines having a round cross-section.

8. The procedure of claim 2, wherein the second axial passages are formed to receive and retain service drop lines having a rectangular cross-section.
